(19) United States
(12) Patent Application Publication
(10) Pub. No.: US 2007/0213417 A1
(43) Pub. Date: Sep. 13, 2007

(54) Open-Cell Foam Materials, Method For Producing Them And Their Use

(75) Inventors: Martin Stork, Mannheim (DE); Moritz Ehrenstein, Ludwigshafen (DE); Thomas Breiner, Schifferstadt (DE); Andreas Poppe, Dorverden (DE); Armin Alteheld, Bad Kreuznach (DE); Volker Warzelhan, Weisenheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/547,474

(22) PCT Filed: Apr. 14, 2005
(86) PCT No.: PCT/EP05/03920

§ 371 Date: Oct. 5, 2006

(30) Foreign Application Priority Data
Apr. 20, 2004 (DE) 10 2004 019 708.3
Mar. 8, 2005 (DE) 10 2005 011 044.4

(51) Int. Cl. C08J 9/26

(52) U.S. Cl. 521/61

(57) ABSTRACT

Modified open-cell foams having a density in the range from 5 to 1000 kg/m³, a mean pore diameter in the range from 1 μm to 1 mm, a BET surface area in the range from 0.1 to 50 m²/g and an acoustic absorption factor of more than 50% at a frequency of 2000 Hz at a layer thickness of 50 mm, comprising in the range from 1 to 4000 ppm, based on the weight of the unmodified open-cell foam, fixed particles (b) having a mean diameter (number average) in the range from 5 nm to 900 nm.

The present invention relates to modified open-cell foams having a density in the range from 5 to 1000 kg/m³, a mean pore diameter in the range from 1 μm to 1 mm, a BET surface area in the range from 0.1 to 50 m²/g and an acoustic absorption factor in the range of more than 50% at a frequency of 2000 Hz at a layer thickness of 50 mm, comprising in the range from 1 to 4000 ppm, based on the weight of the unmodified open-cell foam, fixed particles (b) having a mean diameter (number average) in the range from 5 nm to 900 nm.

The present invention furthermore relates to a process for the production of open-cell foams according to the invention and the use of open-cell foams according to the invention for the production of automotive parts, filters and air conditioning systems.

Foams, especially so-called open-cell foams, have numerous applications. In particular, open-cell foams comprising synthetic materials have proven to be versatile. Seat cushions, filter materials, air conditioning systems and automotive parts may be mentioned by way of example. Attempts are made especially to use open-cell foams in ventilation systems of automobiles in order to permit draught-free ventilation in automobiles. However, attempts to date have been unsuccessful. For example, it has been observed that the acoustic absorption is not sufficient and passengers in the interior of the automobile complain about a considerable amount of noise. Furthermore, the life of open-cell foams known to date has proven to be insufficient.

WO 02/062881 discloses that surface-modified nanoparticles having a diameter of less than 100 nm can be incorporated into foam which is suitable, for example, as a constituent for formulations for hair care (page 19, line 19) or for other personal hygiene compositions. According to WO 02/062881, surface-modified nanoparticles—if appropriate combined with the solvent—are combined with a mixture and foaming is then effected (example 1, page 24, line 8 et seq., page 25, line 16 et seq., page 26, line 15 et seq.). The surface-modified nanoparticles according to WO 02/062881 are therefore embedded in the foam and are present on the surface of the foam only in a small proportion, if at all.

The technical properties of the foams known from the prior art can, however, be further improved.

It was therefore the object to provide foams which avoid the disadvantages of the materials known from the prior art. It was furthermore the object to provide a process for the production of novel foams. It was also the object to provide uses of foams, and it was the object to provide methods for using foams.

The modified foams defined at the outset, which are also referred to below as foams according to the invention, were accordingly found.

The modified foams according to the invention are open-cell foams, i.e. those foams in which at least 50% of all lamellae are open, preferably from 60 to 100% and particularly preferably from 65 to 99.9%, determined according to DIN ISO 4590.

The modified foams according to the invention are preferably rigid foams, i.e. in the context of the present invention foams which have a compressive strength of 1 kPa or more at a compression of 40%, determined according to DIN 53577.

Modified foams according to the invention have a density in the range from 5 to 1000 kg/m³, preferably from 6 to 300 kg/m³ and particularly preferably in the range from 7 to 100 kg/m³.

Modified foams according to the invention have a mean pore diameter (number average) in the range from 1 μm to 1 mm, preferably from 50 to 500 μm, determined by evaluating micrographs of sections.

Modified foams according to the invention have a BET surface area in the range from 0.1 to 50 m²/g, preferably from 0.5 to 20 m²/g, determined according to DIN 66131.

Modified foams according to the invention have an acoustic absorption factor of more than 50%, preferably at least 90%, in special cases up to 100%, measured according to DIN 52215 at a frequency of 2000 Hz and a layer thickness of the relevant foam of 50 mm.

In a special embodiment of the present invention, modified foams according to the invention have an acoustic absorption factor of more than 0.5, in special cases up to 1, measured according to DIN 52212, at a frequency of 2000 Hz and a layer thickness of the relevant foam of 40 mm.

Modified foams according to the invention comprise in the range from 1 to 4000 ppm, based on the weight of the corresponding unmodified foam, of fixed particles (b) having a mean diameter (number average) in the range from 5 nm to 900 nm, preferably from 6 to 500 nm and particularly preferably from 8 to 100 nm. Particles (b) are preferably inorganic particles which can be chemically modified. Very particularly preferably, particles (b) carry functional groups which enable particles (b) to bind to the unmodified foam. Particularly preferred functional groups are isocyanate groups, blocked or unblocked, hydroxyl groups, methylol groups, amino groups, oxirane groups, aziridine groups, keto groups, aldehyde groups, carboxylic anhydride groups and carboxyl groups, which enable particles (b) to bind to the unmodified foam covalently by, for example, addition reactions, condensation reactions, coupling reactions and especially by etherification reactions or esterification reactions or urethane formation reactions. Other preferred functional groups are those which enable particles (b) to form non-covalent interactions with unmodified foam, for example ionic interactions, dipolar interactions, hydrogen bridge bonds, van der Waals interactions.

Examples of particularly suitable inorganic materials for particles (b) are:

metals, metal chalcogenides, such as, for example, oxides or sulfides, metal carbonates, metal sulfates, for example: CaCO₃, aluminum oxide, titanium dioxide, calcium sulfide, calcium selenide, graphite and in particular silicon dioxide, for example as colloidal silica gel or as pyrogenic silica gel. Very particularly preferred are CaCO₃, aluminum oxide, graphite and especially silicon dioxide, for example as colloidal silica gel or as pyrogenic silica gel.

Examples of particularly suitable organic materials for particles (b) are crosslinked or uncrosslinked polymers which can be prepared by free radical, anionic, cationic or metal-catalyzed polymerization, by polyaddition, polycondensation or other polymerization processes, for example polystyrene, polyacrylates (MMA, MA), polybutadiene, polysiloxanes, polycarbonate, polyesters, polyamides, polysulfones, polyetherketones, polyurethanes, polyoxymethylene, polyolefins, aminoplasts, for example melamine, formaldehyde resin or urea/formaldehyde resins, in particular melamine/formaldehyde resins, and furthermore epoxy resins, but also polymers of natural substances, for example polysaccharides or cellulose. Further particularly suitable organic materials for particles (b) are described in: Modern Plastics Handbook, Modern Plastics, Charles A. Harper (Editor in Chief), ISBN 0-07-026714-6, 1999, McGraw-Hill.

In an embodiment of the present invention, modified foams according to the invention are those based on synthetic organic foam, for example based on organic unmodified foams, such as, for example, foams based on urea/formaldehyde resins, foams based on phenol/formaldehyde resins and in particular foams based on polyurethanes or aminoplast/formaldehyde resins, in particular melamine/formaldehyde resins, the latter also being referred to as polyurethane foams or melamine foams in the context of the present invention. This is to be understood as meaning that foams according to the invention are produced from open-cell foams which comprise synthetic organic materials, preferably polyurethane foams or melamine foams.

The present invention furthermore relates to a process for the production of modified foams according to the invention, also referred to below as production process according to the invention. In the production process according to the invention,
(a) open-cell foams having a density in the range from 5 to 1000 kg/m³, a mean pore diameter in the range from 1 μm to 1 mm, a BET surface area of from 0.1 to 50 m²/g and an acoustic absorption factor of more than 50% at a frequency of 2000 Hz at a layer thickness of 50 mm are brought into contact
(b) with particles having a mean diameter (number average) in the range from 5 nm to 900 nm.

The foams (a) used for carrying out the process according to the invention are also referred to very generally as unmodified foams in the context of the present invention.

The production process according to the invention is carried out starting from open-cell foams (a), in particular from foams in which at least 50% of all lamellae are open, preferably from 60 to 100% and particularly preferably from 65 to 99.9%, determined according to DIN ISO 4590.

Foams (a) used as starting material are preferably rigid foams, i.e. in the context of the present invention foams which have a compressive strength of 1 kPa or more at a compression of 40%, determined according to DIN 53577.

Foams (a) used as starting material have a density in the range from 5 to 1000 kg/m³, preferably from 6 to 300 kg/m³ and particularly preferably in the range from 7 to 100 kg/m³.

Foams (a) used as starting material have a mean pore diameter (number average) in the range from 1 μm to 1 mm, preferably from 50 to 500 μm, determined by evaluating micrographs of sections.

Foams (a) used as starting material have a BET surface area in the range from 0.1 to 50 m²/g, preferably from 0.5 to 20 m²/g, determined according to DIN 66131.

Foams (a) used as starting material have an acoustic absorption factor of more than 50%, measured according to DIN 52215 at a frequency of 2000 Hz and a layer thickness of the relevant foam (a) of 50 mm.

In a special embodiment of the present invention, foams (a) used as starting material have an acoustic absorption factor of more than 0.5, measured according to DIN 52212 at a frequency of 2000 Hz and a layer thickness of the relevant foam (a) of 40 mm.

Foams (a) used as starting material may have any desired geometrical shapes, for example sheets, spheres, cylinders, powders, cubes, flocks, cuboids, saddle elements, rods or square columns. The size dimensions of foams (a) used as starting material are not critical.

In an embodiment of the present invention, foams (a) comprising synthetic organic material, preferably polyurethane foams or melamine foams, are used as starting material.

Polyurethane foams particularly suitable as starting material for carrying out the process according to the invention are known as such. They are produced, for example, by reacting
i) one or more polyisocyanates, i.e. compounds having two or more isocyanate groups,
ii) with one or more compounds having at least two groups which are reactive toward isocyanate, in the presence of
iii) one or more blowing agents,
iv) one or more initiators
v) and one or more catalysts and
i) so-called cell openers.

Initiators iv) and blowing agents iii) may be identical.

Examples of suitable polyisocyanates i) are aliphatic, cycloaliphatic, araliphatic and preferably aromatic polyfunctional compounds known per se and having two or more isocyanate groups.

The following may be mentioned specifically by way of example:

C₄-C₁₂-alkylene diisocyanates, preferably hexamethylene 1,6-diisocyanate; cycloaliphatic diisocyanates, such as, for example, cyclohexane 1,3-diisocyanate and cyclohexane 1,4-diisocyanate and any desired mixtures of these isomers, 1-isocyanato-3,3,5-trimethyl-5-isocyanatomethylcyclohexane (isophorone diisocyanate, IPDI), preferably aromatic di- and polyisocyanates, such as, for example, toluene 2,4- and 2,6-diisocyanate and corresponding isomer mixtures, diphenylmethane 4,4′-, 2,4′- and 2,2′-diisocyanate and corresponding isomer mixtures, mixtures of diphenylmethane 4,4′- and 2,4′-diisocyanates, polyphenylpolymethylene polyisocyanates, mixtures of diphenylmethane 4,4′-, 2,4′- and 2,2′-diisocyanates and polyphenylpolymethylene polyisocyanates (crude MDI) and mixtures of crude MDI with toluene diisocyanates. Polyisocyanates may be used individually or in the form of mixtures.

Di- and polyols, in particular polyetherpolyols (polyalkylene glycols), which are prepared by methods known per se, for example are obtainable by alkali metal hydroxide-catalyzed polymerization of one or more alkylene oxides, such as, for example, ethylene oxide, propylene oxide or butylene oxide, may be mentioned as examples of ii) compounds having at least two groups which are reactive toward isocyanate.

Very particularly preferred compounds ii) are ethylene glycol, propylene glycol, butylene glycol, 1,3-propanediol, 1,4-butanediol, 1,6-hexanediol, diethylene glycol, dipropylene glycol, triethylene glycol, tripropylene glycol, tetraethylene glycol, pentaethylene glycol and hexaethylene glycol.

The following are suitable as blowing agents iii): water, inert gases, in particular carbon dioxide, and so-called physical blowing agents. Physical blowing agents are compounds which are inert to the starting components, are liquid at least at room temperature and evaporate under the conditions of the urethane reaction. The boiling point of these compounds is preferably below 110° C., in particular below 80° C. The physical blowing agents include inert gases, which are introduced into the starting components i) and ii) or are dissolved in them, for example carbon dioxide, nitrogen or noble gases.

Suitable compounds liquid at room temperature are generally selected from the group consisting of alkanes and/or cycloalkanes having at least 4 carbon atoms, dialkyl ethers, esters, ketones, acetals, fluoroalkanes having 1 to 8 carbon atoms and tetraalkylsilanes having 1 to 3 carbon atoms in the alkyl chain, in particular tetramethylsilane.

The following may be mentioned as examples: propane, n-butane, isobutane and cyclobutane, n-pentane, isopentane and cyclopentane, cyclohexane, dimethyl ether, methyl ethyl ether, methyl tert-butyl ether, methyl formate, acetone and fluorinated alkanes which can be degraded in the troposphere and are therefore harmless for the ozone layer, such as trifluoromethane, difluoromethane, 1,1,1,3,3-pentafluorobutane, 1,1,1,3,3-pentafluoropropane, 1,1,1,2-tetrafluoroethane, 1,1,1-trifluoro-2,2,2-trichloroethane, 1,1,2-trifluoro-1,2,2-trichloroethane, difluoroethanes and heptafluoropropane. Said physical blowing agents can be used alone or in any desired combinations with one another.

The use of perfluoroalkanes for producing fine cells is disclosed in EP-A 0 351 614.

For example, the following are suitable as initiators iv): water, organic dicarboxylic acids, aliphatic and aromatic, optionally N-mono- and N,N— and N,N′-dialkyl-substituted diamines having 1 to 4 carbon atoms in the alkyl radical, such as, for example, optionally N-mono- and N,N-dialkyl-substituted ethylenediamine, diethylenetriamine, triethylenetetramine, 1,3-propylenediamine, 1,3- and 1,4-butylenediamine, 1,2-, 1,3-, 1,4-, 1,5- and 1,6-hexamethylenediamine, aniline, phenylenediamines, 2,3-, 2,4-, 3,4- and 2,6-toluylenediamine and 4,4′-, 2,4′- and 2,2′-diaminodiphenylmethane.

The catalysts known in polyurethane chemistry are suitable as catalysts v), for example tertiary amines, such as, for example, triethylamine, dimethylcyclohexylamine, N-methylmorpholine, N,N′-dimethylpiperazine, 2-(dimethylaminoethoxy)ethanol, diazabicyclo[2.2.2]octane and the like, and in particular organic metal compounds, such as titanic esters, iron compounds, such as, for example, iron(III) acetylacetonate, tin compounds, e.g. tin diacetate, tin dioctanoate, tin dilaurate or the dialkyl derivatives of dialkyltin salts of aliphatic carboxylic acids, such as dibutyltin diacetate and dibutyltin dilaurate.

Polar polyetherpolyols (polyalkylene glycols), i.e. those having a high content of ethylene oxide in the chain, preferably of at least 50% by weight, may be mentioned by way of example as cell openers vi). These have a cell-opening effect by separation and influence on the surface tension during foaming.

i) to vi) are used in the ratios customary in polyurethane chemistry.

Aminoplast foams suitable as starting material for carrying out the production process according to the invention and particularly suitable melamine foams are known as such. They are produced, for example, by foaming of
ii) an aminoplast precondensate or melamine/formaldehyde precondensate which, in addition to formaldehyde, may comprise further carbonyl compounds, such as, for example, aldehydes, incorporated in the form of condensed units,
iii) one or more blowing agents,
iv) one or more emulsifiers,
v) one or more curing agents.

Aminoplast precondensates and in particular melamine/formaldehyde precondensates vii) may be unmodified, but may also be modified, for example up to 50 mol %, preferably up to 20 mol %, of the melamine may be replaced by other thermosetting plastics formers known per se, for example alkyl-substituted melamine, urea, urethane, carboxamides, dicyandiamide, guanidine, sulfurylamide, sulfonamide, aliphatic amines, phenol and phenol derivatives. In addition to formaldehyde, modified melamine/formaldehyde precondensates may comprise, for example, acetaldehyde, trimethylolacetaldehyde, acrolein, furfurol, glyoxal, phthaldialdehyde (1,2-phthaldialdehyde) and terephthaldialdehyde as further carbonyl compounds incorporated in the form of condensed units.

The same compounds as described under iii) can be used as blowing agents viii).

Conventional nonionogenic, anionic, cationic or betaine surfactants may be used as emulsifiers ix), in particular C₁₂-C₃₀-alkanesulfonates, preferably C₁₂-C₁₈-alkanesulfonates, and polyethoxylated C₁₀-C₂₀-alkyl alcohols, in particular of the formula R⁶—O(CH₂—CH₂—O)ₓ—H, where R⁶ is selected from C₁₀-C₂₀-alkyl and x may be, for example, an integer in the range from 5 to 100.

Particularly suitable curing agents x) are acidic compounds, such as, for example, inorganic Brønsted acids, e.g. sulfuric acid or phosphoric acid, organic Brønsted acids, such as, for example, acetic acid or formic acid, Lewis acids and also so-called latent acids.

Examples of suitable melamine foams are to be found in EP-A 0 017 672.

Foams (a) used as starting materials can of course comprise additives and compounding materials which are customary in foam chemistry, for example antioxidants, flameproofing agents, fillers, odorous substances, colorants, such as, for example, pigments or dyes, and biocides, for example

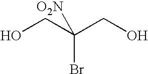

Foams (a) characterized above are brought into contact according to the invention with particles (b) having a mean diameter (number average) in the range from 5 nm to 900 nm, preferably from 6 to 500 nm and particularly preferably from 8 to 100 nm, determined, for example, according to ISO 13321.

Particles (b) may be inorganic or organic particles, i.e. particles which predominantly comprise inorganic or organic material. Organically modified inorganic particles (b) are also referred to below as modified inorganic particles (b).

Particles (b) preferably carry functional groups and do so either because of their nature or after an appropriate chemical modification.

Particles (b) are preferably inorganic particles which may be chemically modified. Very particularly preferably, particles (b) carry functional groups which enable particles (b) to bind to unmodified foam (a). Particularly preferred functional groups are isocyanate groups, blocked or unblocked, hydroxyl groups, methylol groups, amino groups, oxirane groups, aziridine groups, keto groups, aldehyde groups, silyl groups, carboxylic anhydride groups and carboxyl groups, which enable particles (b) to undergo covalent bonding to the unmodified foam (a) by, for example, addition reactions, condensation reactions, coupling reactions and especially by etherification reactions or esterification reactions or urethane formation reactions. Other preferred functional groups are those which enable particles (b) to form noncovalent interactions with unmodified foam (a), for example ionic interactions, dipolar interactions, hydrogen bridge bonds or van der Waals interactions.

Preferred silyl groups are selected from —SiX(R¹)₂, —SiX₂R¹ and —SiX₃, where the variables are selected as follows:
R¹ are identical or different and are selected from C₁-C₁₀-alkyl, such as, for example, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl and n-decyl; particularly preferably C₁-C₄-alkyl, such as methyl, ethyl, n-propyl, isopropyl, n-butyl, isobutyl, sec-butyl and tert-butyl, in particular methyl;
X are identical or different and are selected from
   hydrogen, chlorine and C₁-C₁₀-alkoxy, preferably C₁-C₆-alkoxy, such as methoxy, ethoxy, n-propoxy, isopropoxy, n-butoxy, isobutoxy, sec-butoxy, tert-butoxy, n-pentyloxy, isopentyloxy, n-hexyloxy and isohexyloxy, particularly preferably methoxy and ethoxy.

Examples of particularly suitable inorganic materials for particles (b) are: metals, metal chalcogenides, such as, for example, oxides or sulfides, metal carbonates, metal sulfates, for example: CaCO₃, aluminum oxide, titanium dioxide, calcium sulfide, calcium selenide, graphite and in particular silicon dioxide, for example as colloidal silica gel or as pyrogenic silica gel. Very particularly preferred are CaCO₃, aluminum oxide, graphite and in particular silicon dioxide, for example as colloidal silica gel or as pyrogenic silica gel.

Examples of particularly suitable organic materials for particles (b) are crosslinked or uncrosslinked polymers which can be prepared by free radical, anionic, cationic or metal-catalyzed polymerization, by polyaddition, polycondensation or other polymerization processes, for example polystyrene, polyacrylates (MMA, MA), polybutadiene, polysiloxanes, polycarbonate, polyesters, polyamides, polysulfones, polyetherketones, polyurethanes, polyoxymethylene, polyolefins, aminoplasts, for example melamine/formaldehyde resin or urea/formaldehyde resins, epoxy resins, but also polymers comprising natural substances, for example polysaccharides or cellulose. Further particularly suitable organic materials for particles (b) are described in: Modern Plastics Handbook, Modern Plastics, Charles A. Harper (Editor in Chief), ISBN 0-07-026714-6, 1999, McGraw-Hill.

Functional groups can be bound to particles (b) directly or via a spacer.

Chemically modified particles (b) are very particularly preferred. Chemically modified particles (b) can be prepared by a procedure in which

(b1) a solid in particulate form, for example a silica gel, in particular a colloidal silica gel or a pyrogenic silica gel, is reacted with

(b2) one or more modifying reagents which carry two or more functional groups which, if appropriate, are blocked.

Suitable modifying reagents (b2) may correspond, for example, to the general formula I 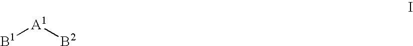
where B¹ and B² may be identical or different and correspond to functional groups which, if appropriate, are blocked (protected).

Suitable spacers A¹ are, for example,

C₁-C₂₀-alkylene, unsubstituted or mono- or polysubstituted, for example by one or more C₁-C₄-alkyl groups, one or more C₆-C₁₄-aryl groups, one or more C₁-C₁₀-alkoxy groups or one or more fluorine or chlorine atoms. The following may be mentioned by way of example: —CH₂—, —CH₂—CH₂—, —(CH₂)₃—, —(CH₂)₄—, —(CH₂)₅—, —(CH₂)₆—, —(CH₂)₇—, —(CH₂)₈—, —(CH₂)₉—, —(CH₂)₁₀—, —(CH₂)₁₂—, —(CH₂)₁₄—, —(CH₂)₁₆—, —(CH₂)₁₈—, —(CH₂)₂₀—, —CH₂—CH(CH₃)—, —CH₂—CH(C₂H₅)—, —CH₂—CH(iso-C₃H₇)—, —CH₂—CH(tert.-C₄H₉)—, —CH₂—CH(C₆H₅)—, syn- and anti- —CH(CH₃)—CH(CH₃)—, syn- and anti- —CH(CH₂CH₅)—CH(C₂H₅)—, syn- and anti- —CH(C₆H₅)—CH(C₆H₅)—, —CH₂—C(CH₃)₂—CH₂—, —C(CH₃)₂—C(CH₃)₂—, —CH(CH₃)₂—CH₂—C(CH₃)₂—, —CH(CH₃)—CH(C₆H₅)—, —CH₂—CH(CH₃)—CH₂—, —CH₂—CH(tert-C₄H₉)—CH₂—;

C₆-C₁₄-arylene, for example ortho-, meta- or para-phenylene, 1,7-naphthylene, 2,6-naphthylene, 1,4-naphthylene,

C₄-C₁₂-cycloalkylene, for example

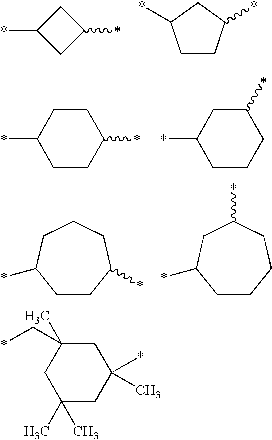

C₂-C₂₀-alkylene, unsubstituted or mono- or polysubstituted, for example by one or more C₁-C₄-alkyl groups or one or more C₆-C₁₄-aryl groups, in which one or more nonneighboring C atoms are substituted by oxygen, for example —CH₂—O—, —CH₂—O—CH₂—, —(CH₂)₂—O—(CH₂)₂—, —[(CH₂)₂—O]₂—(CH₂)₂—, —[(CH₂)₂—O]₃—(CH₂)₂—.

Examples of B¹ and B² are

groups of the general formula B-I

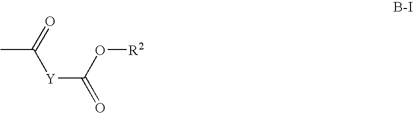

groups of the general formula B-II

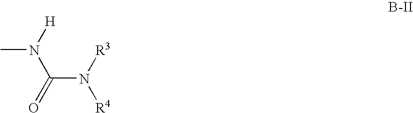

Here, the variables are defined as follows:
Y is selected from oxygen and N—H,
R² is selected from C₁-C₂₀-alkyl, preferably C₁-C₁₀-alkyl, such as, for example, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl, preferably branched C₃-C₁₀-alkyl, for example isopropyl, tert-butyl, isoamyl, tert-amyl, neopentyl, benzyl, fluorenyl and phenyl.
R³ and R⁴ are identical or different and are selected from C₁-C₁₀-alkyl, such as, for example, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl and n-decyl; particularly preferably C₁-C₄-alkyl, such as methyl, ethyl, n-propyl, isopropyl, n-butyl, isobutyl, sec-butyl and tert-butyl, in particular n-butyl;
   -A²-SiX₃, -A²-SiR¹X₂, -A²-SiX(R¹)₂, where A² is selected from C₁-C₂₀-alkylene, unsubstituted or mono- or polysubstituted, for example by one or more C₁-C₄-alkyl groups, one or more C₆-C₁₄-aryl groups, one or more C₁-C₁₀-alkoxy groups or one or more fluorine or chlorine atoms.
   The following may be mentioned by way of example for A²: —CH₂—, —CH₂—CH₂—, —(CH₂)₃—, —(CH₂)₄—, —(CH₂)₅—, —(CH₂)₆—, —(CH₂)₇—, —(CH₂)₈—, —(CH₂)₉—, —(CH₂)₁₀—, —(CH₂)₁₂—, —(CH₂)₁₄—, —(CH₂)₁₆—, —(CH₂)₁₈—, —(CH₂)₂₀—, —CH₂—CH(CH₃)—, —CH₂—CH(C₂H₅)—, —CH₂—CH(iso-C₃H₇)—, —CH₂—CH(tert.-C₄H₉)—, —CH₂—CH(C₆H₅)—, syn- and anti- —CH(CH₃)—CH(CH₃)—, syn- and anti- —CH(CH₂CH₅)—CH(C₂H₅)—, syn- and anti- —CH(C₆H₅)—CH(C₆H₅)—, —CH₂—C(CH₃)₂—CH₂—, —C(CH₃)₂—C(CH₃)₂—, —C(CH₃)₂—CH₂—C(CH₃)₂—, —CH(CH₃)—CH(C₆H₅)—, —CH₂—CH(CH₃)—CH₂—, —CH₂—CH(tert-C₄H₉)—CH₂—;
   very particularly preferably —CH₂—CH₂—, —(CH₂)₃—, —(CH₂)₄—;
   and R¹ and X are as defined above;
   or R³ and R⁴ are linked to one another with formation of a 3- to 10-membered ring, preferably of a 5- to 7-membered ring. Thus, for example, R³ and R⁴ together may be:
   C₁-C₈₀-alkylene, unsubstituted or mono- or polysubstituted, for example by one or more C₁-C₄-alkyl groups, one or more C₆-C₁₄-aryl groups, one or more C₁-C₁₀-alkoxy groups or one or more fluorine or chlorine atoms.
   The following may be mentioned by way of example: —CH₂—, —CH₂—CH₂—, —(CH₂)₃—, —(CH₂)₄—, —(CH₂)₅—, —(CH₂)₆—, —(CH₂)₇—, —(CH₂)₈—, —(CH₂)₉—, —(CH₂)₁₀—, —CH₂—CH(CH₃)—, —CH₂—CH(C₂H₅)—, —CH₂—CH(iso-C₃H₇)—, —CH₂—CH(tert-C₄H₉)—, —CH₂—CH(C₆H₅)—, syn- and anti- —CH(CH₃)—CH(CH₃)—, syn- and anti- —CH(CH₂CH₅)—CH(C₂H₅)—, syn- and anti- —CH(C₆H₅)—CH(C₆H₅)—, —CH₂—C(CH₃)₂—CH₂—, —C(CH₃)₂—C(CH₃)₂—, —C(CH₃)₂—CH₂—C(CH₃)₂—, —CH(CH₃)—CH(C₆H₅)—, —CH₂—CH(CH₃)—CH₂—, —CH₂—CH(tert.-C₄H₉)—CH₂—;
   very particularly preferably —CH₂—CH₂—, —(CH₂)₃—, —(CH₂)₄—;
   C₁-C₈-alkylene in which one to 4 carbon atoms may be replaced by N—H or N—R¹ or up to 3 nonneighboring carbon atoms by oxygen, for example —CH₂—O—, —CH₂—O—CH₂—, —(CH₂)₂—O—(CH₂)₂—, —[(CH₂)₂—O]₂—(CH₂)₂—, —[(CH₂)₂—O]₃—(CH₂)₂—, C₂-C₈-alkylidene having one or more double bonds, it being possible for up to 4 carbon atoms to be replaced by nitrogen, very particularly preferably —CH═C(CH₃)—C(CH₃)═C—, —CH═C(CH₃)—C(CH₃)═N— and —C(CH₃)═CH—C(CH₃)═N—.

In an embodiment of the present invention, B¹ and B² are different.

In another embodiment of the present invention, B¹ and B² are different and correspond to the same functional groups which are blocked in different ways.

In another embodiment of the present invention, B¹ and B² are identical but are present in positions with different reactivity of the molecule of the general formula 11; thus, for example, B¹ may be a primary functional group and B² may be a secondary functional group. In another example, B¹ is a sterically unhindered functional group and B² is a sterically hindered functional group.

Very particularly suitable modifying reagents (b2) are the reagents b2.1 to b2.4

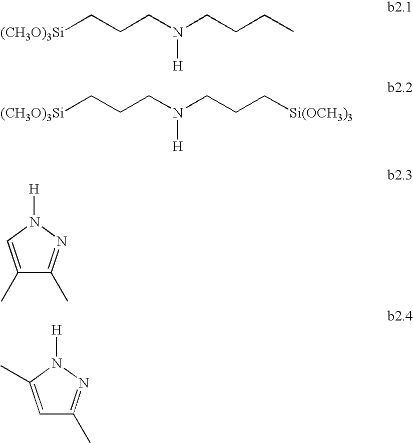

In an embodiment of the present invention, particles (b) are first modified by introducing functional groups which, if appropriate, are blocked, and the modified particles (b) are then reacted with one or more reagents which saturate all further reactive groups in modified particles (b). For example, if particles (b) are silica gels, modification can first be effected by introducing functional groups, and remaining hydroxyl groups can then be silylated by reaction with, for example, alkoxytrialkylsilanes.

The chemical modification of particles (b) can of course be carried out in the presence of one or more catalysts which, for example, facilitate the elimination of protective groups or reactions of functional groups present on the surface of unmodified particles with modifying reagent.

For carrying out the process according to the invention, foam (a) and particles (b) are brought into contact.

In an embodiment of the present invention, unmodified foam (a) is brought into contact with from 1 to 4000 ppm of particles (b), based on unmodified foam (a), preferably from 5 to 1000 ppm, where ppm in the context of the present invention always means ppm by mass. For example, it is possible to bombard unmodified foam (a) with particles.

In an embodiment of the present invention, particles (b) are first dispersed in a solvent or a mixture of solvents, and such a dispersion in the form of an aerosol is applied to unmodified foam (a), for example with the aid of a spray apparatus.

In an embodiment of the present invention, particles (b) are first dispersed in a solvent or a mixture of solvents, and the dispersion thus obtainable is brought into contact with unmodified foam (a), for example by mixing with foam (a). By means of this embodiment, particularly uniform contact of unmodified foam (a) with particles (b) is usually achieved, which can lead to advantageous performance characteristics of modified foams according to the invention.

For example, the following are suitable as solvents:

aromatic hydrocarbons, such as toluene, ortho-xylene, meta-xylene, para-xylene and ethyl benzene;

aliphatic hydrocarbons, such as n-dodecane, isododecane (2,2,4,6,6-pentamethylheptane), n-tetradecane, n-hexadecane, n-octadecane and isomers, individually or as a mixture, of the abovementioned aliphatic hydrocarbons, in particular the mixture of different C₁₂-C₁₈-hydrocarbons which is commercially available as solvent naphtha;

mixtures of the abovementioned aliphatic or aromatic hydrocarbons with from 0.1 to 10% by weight of alcohols, such as, for example, n-hexanol, n-octanol or n-pentanol, chlorinated hydrocarbons, such as, for example, chlorobenzene, ortho-dichlorobenzene and meta-dichlorobenzene.

Suitable concentrations of optionally modified particles (b) in a solvent or a mixture of solvents are, for example, from 0.001 to 75% by weight, preferably from 0.01 to 25% by weight.

In an embodiment of the present invention, the production process according to the invention is carried out without the use of binders. The properties established by the foam formation reaction in the production of foam (a) used as starting material are therefore substantially retained.

In an embodiment of the present invention, (a) and (b) may be allowed to act after having been brought into contact, for example over periods in the range from 5 minutes to 24 hours, preferably from 10 minutes to 10 hours and particularly preferably from 30 minutes to 6 hours.

In an embodiment of the production process according to the invention, (a) and (b) are brought into contact at temperatures in the range from 0° C. to 250° C., preferably from 30° C. to 190° C. and particularly preferably from 50 to 165° C.

In an embodiment of the production process according to the invention, (a) and (b) are first brought into contact at temperatures in the range from 50° C. to 150° C., and the temperature is then changed, for example heating is effected to temperatures in the range from 80° C. to 250° C., preferably from 155° C. to 180° C.

In another embodiment of the production process according to the invention, (a) and (b) are brought into contact initially at temperatures in the range from 0° C. to 120° C., and the temperature is then changed, for example heating is effected to temperatures in the range from 30° C. to 250° C., preferably from 125° C. to 200° C.

In a preferred embodiment of the process according to the invention, solvent and temperature program are chosen so that most structural parameters of foam (a) used as starting material are not substantially changed.

In an embodiment of the present invention, the production process according to the invention is carried out at atmospheric pressure. In another embodiment of the present invention, the production process according to the invention is carried out under super atmospheric pressure, for example at pressures in the range from 1.1 bar to 10 bar. In another embodiment of the present invention, the production process according to the invention is carried out under reduced pressure, for example at pressures in the range from 0.1 mbar to 900 mbar, preferably up to 100 mbar.

In an embodiment of the present invention, (a) and (b) are brought into contact in the presence of at least one solvent and one or more preferably dissolved catalysts which can, for example, facilitate the elimination of one or more protective groups from chemically modified particles (b).

In an embodiment of the present invention, washing can be effected, for example with one or more solvents, after the bringing into contact.

Foams according to the invention and foam produced by the process according to the invention are distinguished by overall advantageous properties. They exhibit good stability to hydrolysis, improved acid resistance and good sound absorption and—for example if they are used for the production of air conditioning systems or automotive parts—are particularly durable. They do not soil or do so only very slowly. Any soiled foams according to the invention can be easily cleaned.

The present invention furthermore relates to the use of modified open-cell foams according to the invention or of open-cell foams modified according to the invention for the production of automotive parts, filters, mist separators or air conditioning systems.

The present invention furthermore relates to a process for the production of automotive parts using modified open-cell foams according to the invention or open-cell foams modified according to the invention. The present invention furthermore relates to a process for the production of filters using modified open-cell foams according to the invention or open-cell foams modified according to the invention. The present invention furthermore relates to a process for the production of air conditioning systems using modified open-cell foams according to the invention or open-cell foams modified according to the invention.

If it is desired to use modified foams according to the invention for the production of filters, bag filters are particularly preferred. If it is desired to use modified foams according to the invention for the production of automotive parts, ventilation units are particularly preferred.

The present invention furthermore relates to automotive parts, filters, mist separators and air conditioning systems produced using or comprising modified open-cell foams according to the invention or open-cell foams modified according to the invention.

The present invention furthermore relates to the use of open-cell foams modified according to the invention for cleaning surfaces.

The present invention furthermore relates to a method for cleaning surfaces using open-cell foams modified according to the invention.

Preferably, foam modified according to the invention is moistened with water and is then passed once or preferably several times over the surface to be cleaned. The contact pressure can be chosen as desired. One or more pieces of foam modified according to the invention can be passed manually or mechanically over the surface to be cleaned.

The following contaminants can be particularly readily removed:

greases, oils, waxes, for example polyethylene wax, paraffin wax, liquid paraffins, ester oils, natural oils and fats, lubricating greases, bearing greases, Stauffer greases, montan waxes,

metal salts of anionic surfactants, such as, for example, lime soap, biofilms, for example mold or Pseudomonas biofilms,

polymers, for example paint splashes, polyurethane foam, silicones (polysiloxanes), residues of lubricants, for example partially coked or partially or completely resinified lubricants, and broken emulsions,

polymer-containing abraded material, for example residues of shoe soles,

colored residues of black or colored pens, for example ink spots, spots of wax crayons, felt pens, colored pencils,

dried-in residues and discolorations of foods, preferably fruit, vegetables, or fruit preparations or vegetable preparations or juices, ketchup, mustard, wine, tea, coffee or blood,

cosmetics, such as, for example, make-up, lipstick, rouge and tusche, such as, for example, mascara,

carbon black, dust, fine dusts, including fine dusts capable of entering the lungs, coarse dust, tobacco dust, resin fumes, fly ash, such as, for example, furnace dust, dust from bulk materials, smelting dust, carbon dust, flotation-dependent dusts, industrial dust, dyes, smoke, zinc powder, fine/coarse powders, flour, white or colored chalk powder.

Suitable surfaces to be cleaned according to the invention are, for example, structured or smooth surfaces which may comprise any desired material, for example stone, concrete, ceramic, wood, metal, painted or unpainted, textile, leather, polymers, glass, board or paper. Surfaces to be cleaned may be, for example, indoors or outdoors. For example, ceramic, in particular ceramic tiles, and wallpapers, such as, for example, woodchip wallpapers, can be particularly readily cleaned.

For moistening, open-cell foam modified according to the invention is brought into contact with suitable liquid, for example water, and excess water is removed. Foam modified according to the invention absorbs, for example, from 0.1 to 0.9 times its own weight of liquid, for example water, preferably from 0.25 to 0.75 times and particularly preferably from 0.45 to 0.55 times.

In many cases, it is not necessary to wring out open-cell foam modified according to the invention which has been brought into contact with suitable liquid. The removal of excess liquid, such as, for example, water, is effected in many cases by simple movement, such as, for example, shaking out.

The durability of open-cell foam modified according to the invention when used for cleaning surfaces is substantially greater than that of the corresponding unmodified open-cell foam.

The invention is explained by working examples.

### WORKING EXAMPLES

The steps I to II were carried out under dry nitrogen.

I. Preparation of a Modifying Reagent

I.1. Preparation of a Partially Silanized Diisocyanate

67 g of trimeric isophorone diisocyanate (IPDI) having a softening point of from 90 to 110° C. as a 70% strength by weight solution in n-butyl acetate/n-heptane (1:1) were diluted with 15 g of an n-butyl acetate/n-heptane (1:1) solvent mixture. 18.1 g of N-(n-butyl)-3-aminopropyltrimethoxysilane (commercially available as Dynasilan 1189 from Degussa) were added dropwise over a period of one hour while cooling, it being ensured that the temperature did not increase above 30° C. After the end of the addition of N-(n-butyl)-3-aminopropyltrimethoxysilane, stirring was carried out for a further hour at 25° C. A solution of partially silanized trimeric IPDI having a solids content of 65% and a degree of silanization of 40 mol %, based on NCO groups used, was obtained. The content of free NCO groups was 4.7 mol %.

I.2 Reaction of the Partially Silanized Diisocyanate Obtained Under I.1

90.3 g of the solution of partially silanized trimeric IPDI, obtained under I.1, were initially taken in a three-necked flask having a stirrer, reflux condenser and thermometer, and 9.7 g of 3,5-dimethylpyrazole were added. Heating to 50° C. was effected with stirring. After 13 hours, free NCO groups were no longer detectable (IR spectroscopy). The solution was cooled to room temperature. A solution of modifying reagent M1 was obtained.

II. Preparation of Dispersions of Chemically Modified Particles (b.1)

11.1 g of the solution of the modifying reagent M1, obtained under I.2, were heated to 70° C. 20 g of a 30% strength by weight solution of a colloidal silica gel having a mean particle diameter (number average) of 13.4 nm in isopropanol and also 1 g of 0.1 N aqueous acetic acid were added in the course of 5 minutes. The mixture thus obtainable was stirred over a period of 2 hours at 70° C., and 0.7 g of trimethoxysilane was then added dropwise in the course of 30 minutes. Thereafter, 10.3 g of solvent naphtha, a mixture of C₁₂-C₁₈-hydrocarbons liquid at room temperature and 1.6 g of n-hexanol were added and stirring was effected for a further 2 hours at 70° C. Thereafter, cooling to 55° C. was effected and readily volatile constituents were distilled off under reduced pressure and at 55° C.

A dispersion of chemically modified particles (b.1) having a solids content of 53% was obtained. The content of isopropanol/n-hexanol was altogether less than 1 % by weight. The calculated content of blocked isocyanate groups was less than 1.77% by weight, based on the total weight of chemically modified particles in the dispersion.

Unmodified colloidal silica gel: The particle diameter distribution was determined with the aid of an Autosizer IIC apparatus from Malvern according to ISO 13321 and gave a maximum at 13.4 nm.

The dispersion thus obtainable (“stock dispersion”) was storage-stable over one month at room temperature and at 40° C.; no increase in viscosity was observable.

The mean hydrodynamic radius of the chemically modified particle was determined at 50 nm with the aid of dynamic light scattering.

In each case 10 g of stock dispersion were diluted with n-hexadecane, in particular
in the volume ratio 1:100 (dispersion 1)
in the volume ratio 1:1000 (dispersion 2).

When the experiment described under II was repeated but solvent naphtha was replaced by n-hexadecane, the same result was obtained.

III. Production of a Modified Foam According to the Invention

III.1 Production of an Unmodified Foam (a1)

In an open vessel, a spray-dried melamine/formaldehyde precondensate (molar ratio 1:3, molecular weight about 500) was added to an aqueous solution comprising 3% by weight of a formic acid and 1.5% by weight of the sodium salt of a mixture of alkanesulfonates having 12 to 18 carbon atoms in the alkyl radical (emulsifier K 30 from Bayer AG), the percentages being based on melamine/formaldehyde precondensate. The concentration of the melamine/formaldehyde precondensate, based on the total mixture of melamine/formaldehyde precondensate and water, was 74%. The mixture thus obtainable was vigorously stirred, after which 20% of n-pentane were added. Stirring was continued (for about 3 min) until a dispersion having a homogeneous appearance formed. This was applied by knife coating to a Teflon-coated glass fabric as substrate material and foamed and cured in a drying oven in which an air temperature of 150° C. prevailed. The boiling point of the n-pentane, which is 37.0° C. under these conditions, resulted as the material temperature in the foam. After from 7 to 8 min, the maximum rise height of the unmodified foam was reached. The unmodified foam (a1) thus obtainable was left in the drying oven for a further 10 min at 150° C.; it was then annealed for 30 min at 180° C.

III.2 Production of Modified Foams S1 According to the Invention

The following properties were determined for the unmodified foam (a1) from example III.1:

99.6% open cells according to DIN ISO 4590,

compressive strength (40%) 1.3 kPa, determined according to DIN 53577,

density 13.0 kg/m³, determined according to EN ISO 845,

mean pore diameter 210 μm, determined by evaluating micrographs of sections,

BET surface area of 6.4 m²/g, determined according to DIN 66131,

acoustic absorption factor of 93%, determined according to DIN 52215,

acoustic absorption factor of more than 0.9, determined according to DIN 52212.

Foam from example III.1 was cut into cylinders having the dimensions of diameter of the base area: 26.5 mm, height: 4 cm. 5 of the foam cylinders described above were initially taken in a flask and flushed with dry nitrogen over a period of 48 hours. Thereafter, 460 ml of dispersion 1 (400 g) were added to them and they were heated to 140° C. 140° C. was maintained over a period of one hour, heating to 160° C. was then effected, and 160° C. was maintained for a further hour. Cooling to room temperature was then effected.

The foam cylinder was separated off and washed once with 100 ml of n-hexadecane, three times with 400 ml portions of toluene and then rinsed with toluene-denatured ethanol.

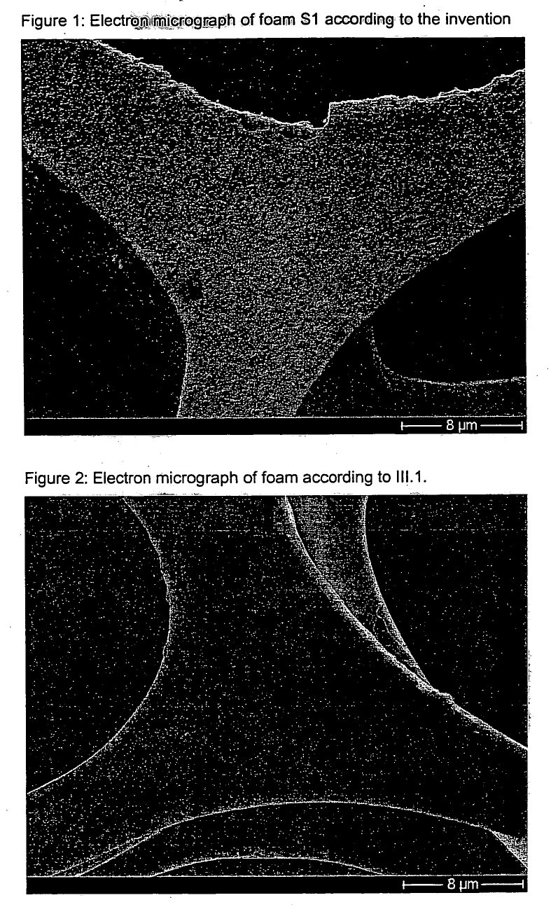

Drying in the air was allowed to take place for 15 hours, followed by drying for 24 hours at 80° C. in a vacuum drying oven. Modified foam S1 according to the invention was obtained. FIG. 1 shows an electron micrograph of foam S1 according to the invention. An electron micrograph of unmodified foam according to III.1 used as starting material is shown as a comparison (FIG. 2).

III.3 Production of Modified Foams S2 According to the Invention

The experiment according to III.2 was repeated, but 460 ml (400 g) of dispersion 2 was used.

Modified foam S2 according to the invention was obtained.

IV. Investigations of the Modified Foams According to the Invention and of a Comparative Sample

Test dust: CaCO₃ having particle diameters in the range from 0.1 μm to 8 μm, mean particle diameter (number average): 5 μm

A dust test apparatus which had the following structure was set up:

The test dust introduced into a cylindrical solids container (diameter 20 mm) and compacted was fed to a rotating brush (brush dispenser RBG 1000 from Pallas) with the aid of a piston.

The piston feed was 1 mm/h and the brush speed was set at 1200 rpm. The test dust present in the brushes was entrained by the compressed air (set pressure 0.9 bar) and introduced into the system via the dispersing cover (in the present case the dispersing cover type A was used). The air stream laden with test dust was aspirated via a tube having a diameter of 2.65 cm, in which the foam treated according to the invention or a comparative sample was clamped. The aspirated volume flow rate was 3 m³/h, resulting in a flow velocity of 1.51 m/s in the tube. The measurements of the test dust content were carried out using an optical particle counter PCS 2000 from Pallas before and after the foam sample.

After 5 minutes in the test dust air stream, the test dust mass concentration in the air was determined. Table 1 shows the measured mass concentrations (mg of test dust per m³ of air) without foam (time=0 min) and after loading with test dust for 5 min. The untreated foam absorbed larger amounts of test dust very rapidly and became blocked within 5 min, whereas the test dust absorption of the foams according to the invention was substantially lower. After 5 min, 5-20% by weight of test dust particles were still allowed through.

TABLE 1

| | Untreated foam (comparative | | |
|---|---|---|---|
| | experiment) | S1 | S2 |
| Time [min] | MC [mg/m³] | MC [mg/m³] | MC [mg/m³] |
| 0* | 44.454 | 93.654 | 86.555 |
| 5 | 0.244 | 6.333 | 16.022 |

*= without foam
MC = Test dust mass concentration [mg/m³]

Cleaning

After the end of the loading with air containing test dust, the foams were removed and were cleaned by shaking briefly. The foams according to the invention which had been treated with particles (b) showed an improved cleaning effect, whereas the untreated foam remained substantially more highly contaminated with test dust.

V. Use of Foam S2 Modified According to the Invention and of Unmodified Foam (a1) for Cleaning Surfaces

V.1. Cleaning of a Woodchip Wallpaper by way of Example

A piece of foam S2 modified according to the invention (own weight 1.3 g) was soaked in water and shaken out. The increase in weight was 0.6 g. It was then passed over a DIN A5 piece of woodchip wallpaper which had been smeared with red wax crayon in the form of 4 lines having a length of 10 cm and a thickness of from 3 to 8 mm. Even with the application of only slight pressure, the smearing was removed. After use, the foam S2 modified according to the invention could be cleaned under running tap water without great mechanical action (less than 0.5 N/cm²). After cleaning, it could be used without limitation for cleaning further surfaces.

A piece of unmodified foam (a1) (own weight 1.3 g) was soaked in water and shaken out. The increase in weight was 120 g. It was then passed over a DIN A5 piece of woodchip wallpaper which had been smeared with red wax crayon in the form of 4 lines having a length of 10 cm and a thickness of from 3 to 8 mm. As a result of water running down, the woodchip wallpaper was thoroughly soaked and became slightly wavy.

A further piece of unmodified foam (a1) (own weight 1.3 g) was soaked in water and wrung out. The weight increase was about 5 g. It was then passed over a DIN A5 piece of woodchip wallpaper which was smeared with red wax crayon in the form of 4 lines having a length of 10 cm and a thickness of from 3 to 8 mm. Even with the application of only slight pressure, the smearing was removed. After use, the unmodified foam (a1) could be superficially cleaned under running tap water with application of mechanical force (repeated mechanical wringing out using more than 0.5 N/cm²) but lost its shape. After cleaning, it could be used only for a limited time for cleaning further surfaces.

V.2 Use of Foam S2 Modified According to the Invention and of Unmodified Foam (a1) for Cleaning the Surface of a Tile

A piece of foam S2 modified according to the invention (own weight 1.3 g) was soaked in water and shaken out. The weight increase was 0.7 g. It was then passed over 0.0225 m² of a ceramic tile which was smeared with yellow chalk (from Rheita-Krautkrämer) in the form of 3 lines having a length of 8 cm and a thickness of from 5 to 10 mm. Even with application of only slight pressure, the smearing was completely removed. After use, the foam S2 modified according to the invention could be cleaned without great mechanical action (less than 0.5 N/cm²), by tapping and subsequent washing under running tap water. After cleaning, it could be used without limitation for cleaning further surfaces.

A piece of unmodified foam (a1) (own weight 1.3 g) was soaked in water and shaken out. The weight increase was about 120 g. It was then passed over 0.0225 m² of a ceramic tile which was smeared with yellow chalk in the form of 3 lines having a length of 8 cm and a thickness of from 5 to 10 mm. A large amount of water with distributed chalk particles collected on the tile. After the cleaning experiment, the unmodified foam (a1) could be superficially cleaned under running tap water with application of mechanical force (repeated mechanical wringing out using more than 0.5 N /cm²) but substantially lost its shape. After cleaning, it could be used only for a limited time for cleaning further surfaces.

A further piece of unmodified foam (a1) (own weight 1.3 g) was soaked in water and wrung out. The weight increase was about 4 g. It was then passed over 0.0225 m² of a ceramic tile which was smeared with yellow chalk in the form of 3 lines having a length of 8 cm and a thickness of from 5 to 10 mm. Even with application of only slight pressure, the smearing was removed. After use, the unmodified foam (a1) could be superficially cleaned under running tap water with application of mechanical force (repeated mechanical wringing out using more than 0.5 N/cm²) but lost its shape. After cleaning, it could be used only for a limited time for cleaning further surfaces.

V.3 Use of Foam S2 Modified According to the Invention and of Unmodified Foam (a1) for Cleaning the Surface of a Sheet of Card

A piece of foam S2 modified according to the invention (own weight 1.3 g) was soaked in water and shaken out. The weight increase was 0.5 g. 0.04 m² of a sheet of card which was smeared with blue pencil (from Staedtler) in the form of 3 lines having a length of 10 cm and a thickness of from 0.2 to 1 mm was then scrubbed with it. With application of only slight pressure, the smearing was virtually completely removed. After use, the foam S2 modified according to the invention could be cleaned under running tap water without great mechanical action (less than 0.5 N/cm²). After cleaning, it could be used without limitation for cleaning further surfaces.

A piece of unmodified foam (a1) (own weight 1.3 g) was soaked in water and shaken out. The weight increase was about 120 g. 0.04 m² of a sheet of card which was smeared with blue pencil in the form of 3 lines having a length of 10 cm and a thickness of from 0.2 to 1 mm was then scrubbed with it. Water collected on the card, impregnated it and gave it a blue discoloration in moistened regions.

A further piece of unmodified foam (a1) (own weight 1.3 g) was soaked in water and wrung out. The weight increase was about 5 g. 0.04 m² of a sheet of card which was smeared with blue pencil in the form of 3 lines having a length of 10 cm and a thickness of from 0.2 to 1 mm was then scrubbed with it. With application of only slight pressure, the smearing was virtually completely removed. After use, the surface of the unmodified foam (a1) could be cleaned under running tap water with application of mechanical force (repeated mechanical wringing out using more than 0.5 N/cm²) but lost its shape. After cleaning, it could be used only for a limited time for cleaning further surfaces.

TABLE 2
Evaluation of the use examples V.1, V.2 and V.3

| | | According to |
|---|---|---|
| | Unmodified (a1) | the invention |
| | (wrung out) | S2 |
| Example V.1 | | |
| Cleaning effect (moist) | ++ | ++ |
| Red wax crayon on woodchip | | |
| wallpaper | | |
| Woodchip wallpaper then | wet | slightly moistened |
| Cleaning under water | − | + |
| Example V.2 | | |
| Cleaning effect (moist) | ++ | ++ |
| Chalk on tile | | |
| Tile then | very wet | moistened |
| Cleaning under water | ∘ | ++ |
| Example V.3 | | |
| Cleaning effect (moist) | + | + |
| Colored pencil on card | | |
| Card then | wet | moistened |
| Cleaning under water | − | + |

Visual evaluation:
++: very good,
+: good,
∘: satisfactory,
−: poor

1. A modified open-cell foam having a density in the range from 5 to 1000 kg/m³, a mean pore diameter in the range from 1 μm to 1 mm, a BET surface area in the range from 0.1 to 50 m²/g and an acoustic absorption factor of more than 50% at a frequency of 2000 Hz at a layer thickness of 50 mm, comprising in the range from 1 to 4000 ppm, based on the weight of the unmodified open-cell foam, fixed particles (b) having a mean diameter (number average) in the range from 5 nm to 900 nm.

2. The process for the production of modified open-cell foams, wherein
(a) open-cell foams having a density in the range from 5 to 1000 kg/m³, a mean pore diameter in the range from 1 μm to 1 mm, a BET surface area of from 0.1 to 50 m²/g and an acoustic absorption factor of more than 50% at a frequency of 2000 Hz at a layer thickness of 50 mm are brought into contact
(b) with particles having a mean diameter (number average) in the range from 5 nm to 900 nm.

3. The process according to claim 2, wherein particles (b) comprise one or more inorganic materials.

4. The process according to claim 2, wherein particles (b) comprise inorganic particles which have, on the surface, functional groups which can react with functional groups which are on the surface of unmodified foams (a).

5. The process according to claim 2, wherein particles (b) are first dispersed in a solvent or a mixture of solvents and then brought into contact with unmodified foam (a).

6. The process according to claim 2, wherein open-cell foams (a) are foams comprising synthetic organic foam.

7. The process according to claim 2, wherein foams (a) are polyurethane foams or aminoplast foams.

8. The process according to claim 2, wherein, after (a) has been brought into contact with (b), heating to temperatures in the range from 30 to 250° C. is effected.

9. The method of using a modified open-cell foams according to claim 1 for the production of automotive parts, filters, mist separators or air conditioning systems.

10. A process for the production of automotive parts using modified open-cell foams according to claim 1.

11. A process for the production of filters using modified open-cell foams according to claim 1.

12. A process for the production of air conditioning systems using modified open-cell foams according to claim 1.

13. A process for the production of mist separators using modified open-cell foams according to claim 1.

14. An automotive part, filter, mist separator or air conditioning system produced using modified open-cell foams according to claim 1.

15. An automotive part, filter, mist separator or air conditioning system comprising modified open-cell foams according to claim 1.

16. The method of using modified open-cell foams according to claim 1 for the cleaning of surfaces.

17. A method for the cleaning of surfaces using modified open-cell foams according to claim 1.

18. The method of using a modified open-cell foams produced by a process according to claim 2 for the production of automotive parts, filters, mist separators or air conditioning systems.

19. A process for the production of automotive parts using modified open-cell foams produced by a process according to claim 2.

20. A process for the production of filters using modified open-cell foams produced by a process according to claim 2.
